(19) United States
(12) Patent Application Publication
(10) Pub. No.: US 2006/0016914 A1
(43) Pub. Date: Jan. 26, 2006

(54) Coated nozzle for laser cutting

(75) Inventors: Frank-Peter Bach, Nurnberg (DE); Kai Hock, Schmolln-Nitzschka (DE); Manfred Hollberg, Rorschach (CH)

Correspondence Address: BROWDY AND NEIMARK, P.L.L.C.;624 NINTH STREET, NW, SUITE 300, WASHINGTON, DC, 20001-5303, US

(73) Assignees: Jurgen Bach Immobilien und Maschinen KG, Nurnberg (DE); Manfred HOLLBERG, Rorschach (CH)

(21) Appl. No.: 11/060,597

(22) Filed: Feb. 18, 2005

(30) Foreign Application Priority Data
Jul. 21, 2004 (EP) 04017190.2

(51) Int. Cl. B05B 1/30; B05B 15/08; A62C 31/02; B05B 1/34

(52) U.S. Cl. 239/533.1; 239/589; 239/587.1

(57) ABSTRACT

The nozzle serves for or for laser cutting. It has a main body and disposed on the main body a wear-resistant coating composed of a protective-coating material that comprises a metal material content and a non-metal material content, wherein the metal material content contains at least one of the metals aluminum, chrome and titanium, and the non-metal material content contains at least one of the elements nitrogen, oxygen, carbon and boron, especially in the form of a nitride, oxy-nitride, carbon nitride, boron nitride or boride.

### BACKGROUND OF THE INVENTION

1. Field of the Invention

The invention relates to a nozzle for cutting or for laser cutting.

2. Background Art

Nozzles for cut processing are subject to high wear stresses. A nozzle of this type has a main body of a relatively soft copper or brass alloy, which consequently has only a low resistance to surface wear. As a result of occurring molten spatter, the nozzle can become thermally and mechanically damaged to such an extent that destruction on the workpiece being processed and also on the processing equipment can occur.

In order to prevent such damage, it is known to provide the main body of the nozzle with a wear-resistant coating of galvanically deposited chrome. However, a galvanic chrome wear-resistant coating of this type tends to create thickened layers in the regions of corners and edges. In the case of the nozzle this occurs mainly in the region of a discharge opening of a nozzle channel. A galvanic interior coating of the nozzle channel is also very difficult to master technically due to the increased layer growth at the discharge opening and the resulting narrowing. This is the reason why the nozzle channel and especially its discharge opening are not galvanically coated with chrome. Impacting material spatter from the workpiece being processed can then gum up and block the nozzle especially in these uncoated regions. This can lead to a reduced service life of the nozzle.

### SUMMARY OF THE INVENTION

It is an object of the invention to present a nozzle of the above-described type that has a long service life.

To meet this object, a nozzle for cutting of for laser cutting is specified to have a main body and disposed on the main body a wear-resistant coating composed of a protective-coating material that comprises a metal material content and a non-metal material content, wherein the metal material content contains at least one of the metals aluminum, chrome and titanium, and the non-metal material content contains at least one of the elements nitrogen, oxygen, carbon and boron. The wear-resistant coating that is provided according to the invention is characterized above all by a high thermal resistance, high oxidation resistance, high protection against material spatter from the workpiece being processed, as well as a high degree of adherence on the copper or brass alloy of the main body. The specifically ceramic protective-coating material may be deposited preferably by means of a deposition from a gas phase. This permits especially the inside and the discharge opening of the nozzle channel to also be provided with a wear-resistant coating. All in all, this results in a noticeable improvement with respect to the wear resistance that is attainable with the inventive nozzle, as compared to the known nozzle with galvanic chrome wear-resistant coating. The inventive nozzle can thus also be used considerably longer.

According to an embodiment the protective-coating material comprises a grain-refining material content with at least one of the elements yttrium, niobium, zirconium and tungsten. This embodiment results in an improved structure, particularly in a refinement of the grain, and therefore in a very advantageous wear resistance. Also improved are the thermal resistance and the attainable hardness. The grain-refining material content is preferably 0.5 to 4% relative to the sum of the atom percentage of the metal content of the material and the grain-refining material content in the protective-coating material.

Details of the invention will become apparent from the ensuing description of exemplary embodiments of the invention, taken in conjunction with the drawing.

### BRIEF DESCRIPTION OF THE DRAWING

FIG. 1 shows a nozzle with a wear-resistant coating;

FIG. 2 shows a system for generating a wear-resistant coating; and

FIG. 3 shows a service-life comparison of an uncoated nozzle and an inventive nozzle.

### DESCRIPTION OF THE PREFERRED EMBODIMENTS

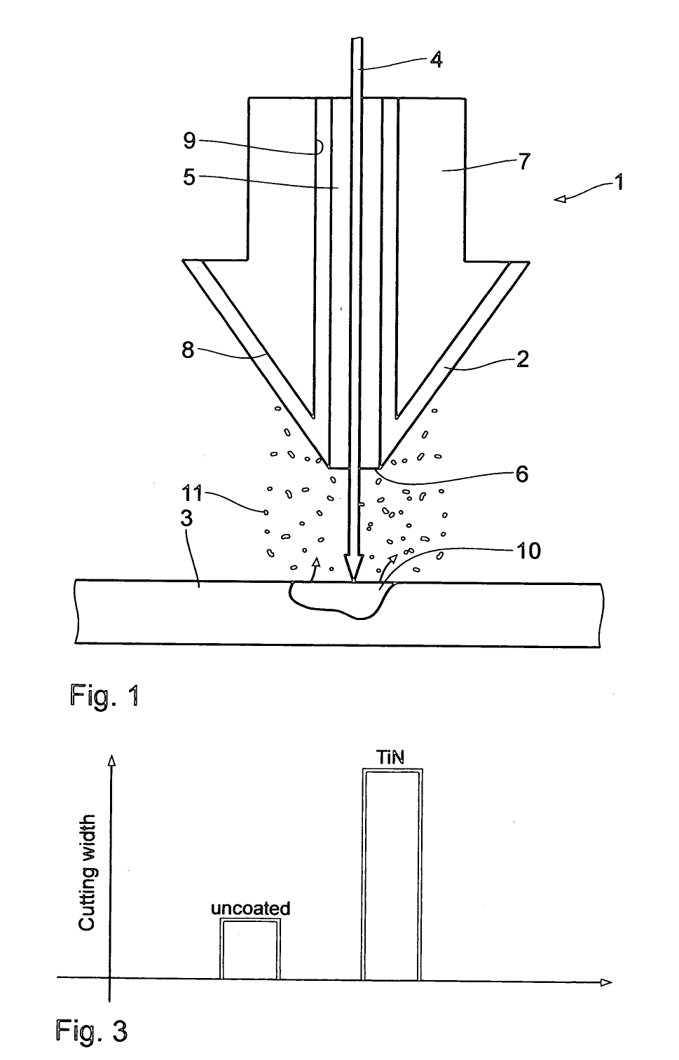

FIG. 1 shows an example embodiment of a nozzle 1 with a wear-resistant coating 2 in a sectional view. The nozzle 1 is part of a device that is not shown in detail for processing a workpiece 3 by means of a laser beam 4. The nozzle 1 has a nozzle channel 5 with a discharge opening 6 facing the workpiece 3. The wear-resistant coating 2 is applied on a main body 7 of the nozzle 1 in such a way that the wear-resistant coating 2 is provided especially on a side 8 of the main body 7 facing the workpiece 3, and especially also on an inner wall 9 of the nozzle channel 5, as well as on the discharge opening 6.

As a rule, the nozzle 1 may be used in different cutting techniques, such as laser cutting.

The laser beam 4 travels through the nozzle channel 5 and, after passing the discharge opening 6, impinges upon the workpiece 3. There it effects a melting and ultimately the intended cutting of the workpiece 3. From a molten mass 10 that is generated by the laser beam 4 in the workpiece 3, very hot and also chemically aggressive material spatter 11 may travel to the nozzle 2. This material spatter 11 can occur both during the cutting process shown in the example. This can cause the nozzle 1 to become damaged. For that reason it is provided at least on its side 8, inside the nozzle channel 9, and at the discharge opening 6 with the wear-resistant coating 2.

The main body 7 consists of a relatively soft and sensitive copper or brass alloy, whereas a very stable ceramic protective-coating material with a high degree of protection is provided for the wear-resistant coating 2. The protective-coating material is deposited onto the main body 7 by means of a physical and/or chemical gas phase deposition process.

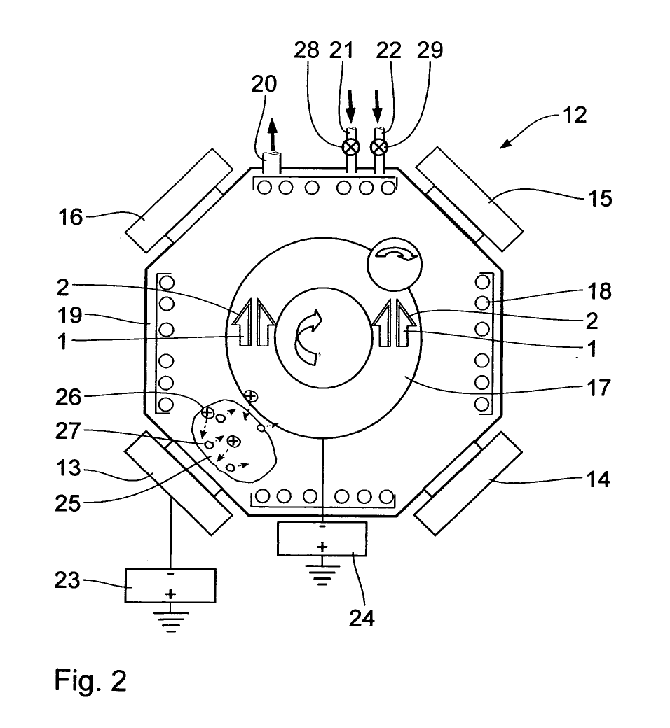

FIG. 2 depicts a system 12 whereby such a gas phase deposition process can be carried out. The system 12 operates according to the sputter process. Alternatively, however, a different suitable gas phase deposition process could also be used, for example a PVD (Physical Vapor Deposition) arc process or a low temperature PACVD (Plasma Assisted Chemical Vapor Deposition) process. The wear-resistant coating 2 that is produced in this manner preferably has a ceramic character. However, it may also have a metallic character.

The system 12 has a multi-cathode system with four cathodes 13, 14, 15 and 16 shown in the example of FIG. 2, which are also referred to as target. A rotatable substrate table 17, on which the nozzle 1 being coated is placed rotatable about at least one additional axis of rotation additionally permits a rotation during the coating process. The possible rotational movement of the substrate table 17 is indicated in FIG. 2 by the arrow.

The substrate table 17 is located inside a recipient 19 that is heatable by means of heating elements 18 and designed as a vacuum chamber and has provided on it a plurality of connections 20, 21 and 22. The connection 20 leads to a vacuum pump that is not shown in FIG. 2. The two connections 21 and 22 serve for the supply of process gases, for example an inert gas such as Argon (Ar) and of reactive gases such as nitrogen (N₂) or oxygen (O₂).

By means of voltage sources 23 and 24, specific potential values can be applied to the cathodes 13, 14, 15 and 16, as well as to the substrate table 17. In FIG. 2, such a connection to the voltage source 14 is shown by way of example only for the cathode 13. The substrate table 17 and also the cathode 13 are negatively biased, the bias at the cathode 13 being for example 200 to 400 V and that at the substrate table 17 for example some 10 to 200 V.

The coating takes place in such a way that, at first, a plasma 25 with positive inert gas ions 26 is created for example by means of ignition. Due to the high negative bias of the cathode 13, the inert gas ions 26 are accelerated in the direction of the cathode 13. On impact, secondary atoms 27 are knocked from the cathode 13. The secondary atoms 27 move randomly as atomized target particles and deposit on opposed surfaces, especially on the workpiece 3.

The negative bias of the substrate table 17 and, accordingly, also the workpieces 3 being coated that are placed on it, serves to prevent impurities. The wear-resistant coating 2 is then continually bombarded with inert-gas ions 26 during its growth and thus cleansed from undesired adsorbates.

The cathodes 13, 14, 15 and 16 may have different material compositions. They may be composed, for example, of metal compounds (AlₓTi_{y}, Alₓ,Cr_{y}, AlₓTi_{y}Cr_{z}Yₙ, TiB₂) or also of the base metals (Al, Ti, Cr, Y). By changing the material composition of the cathodes 13, 14, 15 and 16, the metal material content, in particular, of the growing wear-resistant coating 2 can be varied within a wide range.

Non-metallic material contents of the wear-resistant coating 2 are added, depending on the desired material composition, especially also in gas form. By varying the reactive gas contents, the structural character can be influenced regarding the percentages of nitrides, oxides, carbon nitrides or their mixed phases. Such a variation of the reactive gases is very easily possible by controlling the supplied gas quantity and type. Controlling the gas supply takes place by means of valves 28 and 29 provided in the connections 21 and 22.

The system 12 can also be used to influence and adjust the structural build-up of the growing wear-resistant coating 2. Specifically, a mono-layer, a multi-layer and a nano-crystalline structure can be produced. The measures available for this are, for example, a variation of the effective deposition time, a variation of the cathode output, i.e., the evaporation rate or sputter rate, or a variation of the rotating speed of the substrate table 17. The deposition time with respect to one or more of the cathodes 13, 14, 15 and 16 can be controlled, for example, with the use of shutters that are not explicitly shown in FIG. 2. Other process parameters, such as the temperature regulation, can also be varied with the system 12. A plasma etching may additionally be provided as well.

The system 12 is thus suitable for producing different wear-resistant coatings 2 that may differ both in their material composition as well as in their structural build-up. Specifically, a single-layered or multi-layer coating build-up is possible. The preferred overall thickness of the wear-resistant coatings 2 ranges between 0.5 and 12 μm.

Producible are especially wear-resistant coatings 2 with aluminum (Al), titanium (Ti) and/or chrome (Cr) as the metal components, with oxygen (O), nitrogen (N), carbon (C) and/or boron (B) as the non-metal components, as well as with yttrium (Y), niobium (N), zirconium (Zr) and/or tungsten (W) as the grain-refining components in nearly any desired material composition. One example is a wear-resistant coating 2 of Al-TiCrY(O,N) wherein the metals aluminum, titanium and chrome, as well as the metal yttrium that is provided for grain refinement are present especially in chemically bound form as oxy-nitrides. Wear-resistant coatings 2 in which these metals have other chemical bonds, for example in the form of nitrides, carbon nitrides, boron nitrites or borides, are possible as well.

A test of the various wear-resistant coatings 2 yields their respective properties, especially the material composition, the structural build-up, the hardness, the service life, the adherence, the scratch-resistance, the behavior during application, and the coat-bonding to the main body 7. Additionally, the nozzles 1 can also be characterized with respect to the adhesion of the material spatter 11 from the workpiece to be cut, as well as regarding the wear progression and the wear patterns.

For the chemical determination of the material composition, an EDX (Energy Dispersive X-ray) process, GDOS (Glow Discharge Optical Spectroscopy) process, or SIMS (Secondary Ion Mass Spectrometry) process may be used. Characterizing the structural build-up may take place by means of a metallographic test or scanning electron microscopy (SEM). To determine the hardness and also the elasticity, a smallest load universal hardness test is suitable, for example. The service life can be tested based on a practical application test of the coated nozzles 1 in a cutting machine.

These tests reveal that the nozzle 1 with the wear-resistant coating 2, which is produced by means of the gas phase deposition processes described in connection with FIG. 2, exhibits noticeably better properties than a conventional nozzle with a galvanically applied chrome protection coating. Above all, the wear-resistant coating 2, differently from galvanic chrome coating, can also be applied to the inside wall 9 of the nozzle channel 5 and in the region of the discharge opening 6 with good adherence on the main body 7. Additionally, no undesired thickened layer occurs in the region of the discharge opening 6, which, in contrast thereto, can exist in the case of a galvanic chrome coating. Additionally, the wear-resistant coating 2 that is produced by means of the gas phase deposition process offers protection for the surface of the nozzle 1, which results in a significant reduction in wear compared to conventional galvanically coated nozzles.

The above information applies both to wear-resistant coatings 2 with a mono-layer build-up, i.e., with an essentially homogenous mixed phase, as well as to those with a multi-layer build-up of multiple individual layers. The individual layers may be identical or also different from one another in their respective material composition. A particularly hard and tough wear-resistant coating 2 is obtained by means of a so-called nanostructured multi-layer coating, in which very fine individual layers with layer thicknesses between 3 and 50 nm, preferably between 3 and 20 nm, are provided. Due to the thin layer thickness advantageous mechanical tensions occur between the individual layers, which are also referred to as nano-layers. Even in the case of individual layers that are normally only tough due to their material composition, an overall very high degree of hardness results for the wear-resistant coating 2 owing to these mechanical tensions. Additionally, alternating contents of metal components, preferably titanium and chrome, may be provided in the individual layers. An oxygen content that varies from single coating to single coating is possible as well. The material composition of the individual layers may be repeated in periodic intervals. The wear-resistant coating 2 becomes very resistant with a multi-layer build-up if the total layer thickness is at least 3 μm.

Example embodiments for nozzles 1 with particularly advantageous wear-resistant coatings 2 produced by means of the gas phase deposition process will be described below.

If the nozzle 1 is provided with a wear-resistant coating 2 of chrome nitride (CrN), it is suitable for a mixed application, i.e., for cutting different materials such as steel, stainless steel and coated sheet metals. The higher degree of hardness and temperature resistance, as well as the ceramic character of the wear-resistant coating 2 result in a significantly lower wear of the nozzle 1 as compared to a galvanic chrome coating.

If the nozzle 1 is provided with a wear-resistant coating 2 of titanium nitride (TiN), it has an excellent service life for cutting plastic-coated metal sheets. The material spatters 11 from the released plastic do not adhere to the nozzle surface, or they are easy to remove. FIG. 3 shows a service life comparison between this TiN-coated nozzle 1 and an uncoated nozzle. With the TiN-coated nozzle 1 a significantly greater total cutting width is attainable.

If the nozzle 1 is provided with a wear-resistant coating 2 of titanium boride (TiB₂), it has an excellent service life for cutting aluminum sheets. The material spatters 11 from the released aluminum do not adhere to the nozzle surface, or they are easy to remove.

If the nozzle 1 is provided with a wear-resistant coating 2 of a TiAl-CrY(O,N)-multi-layer coating, it has very good service life properties, a high degree of temperature resistance up to 1100° C., a high degree of oxidation resistance and a high degree of hardness up to 3200 HV. Additionally it exhibits very good non-adhesion tendencies and a very good wear resistance. It is therefore particularly well suited for high-performance cutting of sheet steel.

In the last-mentioned example embodiment, the wear-resistant coating 2 has an approximate material composition as follows:

| | |
|---|---|
| Metal content (Σ 100%) | Non-metal content (Σ 100%) |

| Al | Cr | Ti | Y | O | N |
|---|---|---|---|---|---|
| 72% | 12% | 15% | 1% | 5% | 95% |

This wear-resistant coating 2 consists of a multi-layer build-up whose individual layers were deposited successively in the system 12 by means of the sputter process. The individual layers have a layer-thickness of approximately 4 to 6 nm, wherein the individual layers differ in their respective material composition. The material composition of the individual layers is repeated periodically with a periodic interval of two individual layers. For example, the chrome content in the metal content varies between 6 and 21% and the titanium content between 10 and 25%, and in the non-metal content the oxygen content varies between 1 and 8%. The aluminum and yttrium content, on the other hand, remain essentially constant. The values listed in the above summary table must, therefore, be understood only as approximate data that has been averaged over the total thickness of all individual layers.

What is claimed is :

1. A nozzle for cutting or for laser cutting, having a main body (7) and disposed on the main body (7) a wear-resistant coating (2) composed of a protective-coating material that comprises a metal material content and a non-metal material content, wherein
a) the metal material content contains at least one of the metals aluminum, chrome and titanium, and
b) the non-metal material content contains at least one of the elements nitrogen, oxygen, carbon and boron.

2. A nozzle according to claim 1, wherein the protective-coating material comprises a grain-refining material content with at least one of the elements yttrium, niobium, zirconium and tungsten.

3. A nozzle according to claim 1, wherein the protective-coating material is present in a homogenous mixed phase.

4. A nozzle according to claim 1, wherein the wear-resistant coating (2) is implemented as a multi-layer coating with individual layers, having individual layer thicknesses between 3 and 40 nm.

5. A nozzle according to claim 4, wherein the individual layers of the multi-layer coating have, at least in part, material compositions that differ from one another.

6. A nozzle according to claim 1, wherein the wear-resistant coating (2) has a total thickness of approximately 0.5 to 12 μm.

7. A nozzle according to claim 1, wherein the wear-resistant coating (2) is implemented ceramically.

8. A nozzle according to claim 1, wherein the wear-resistant coating (2) is implemented as a coating deposited from a gas phase.

9. A nozzle according to claim 1, wherein the main body (7) incorporates a nozzle channel (5) having a discharge opening (6) facing a workpiece (3) being processed and that the wear-resistant coating (2) is applied also at the discharge opening (6).

10. A nozzle according to claim 9, wherein the main body (7) incorporates a nozzle channel having an inner wall (9) and that the wear-resistant coating (2) is applied also on the inner wall (9).

11. A nozzle according to claim 5, wherein the metal material content varies from individual layer to individual layer.

12. A nozzle according to claim 11, wherein a chrome content in the metal material content varies between 6 and 21% and a titanium content in the metal material content varies between 10 and 25%.

13. A nozzle according to claim 12, wherein an aluminum content and an yttrium content in the metal material content remain essentially constant.

14. A nozzle according to claim 5, wherein an oxygen content in the non-metal content varies from individual layer to individual layer.

15. A nozzle according to claim 14, wherein the oxygen content varies between 1 and 8%.

16. A nozzle according to claim 5, wherein the material composition in the individual layers is repeated periodically.

17. A nozzle according to claim 16, wherein the material composition of the individual layers is repeated in periodic intervals of two individual layers.

18. A nozzle according to claim 4, wherein the individual layer thicknesses are between 3 and 20 nm.

19. A nozzle according to claim 1, wherein the elements of the non-metal material content have the form of a nitride, oxy-nitride, carbon nitride, boron nitride or boride.
